(19) United States
(12) Patent Application Publication
(10) Pub. No.: US 2015/0295923 A1
(43) Pub. Date: Oct. 15, 2015

(54) ENVIRONMENT BASED SWITCHING BETWEEN TWO DIMENSIONS AND THREE DIMENSIONS

(71) Applicant: AUTODESK, INC., SAN RAFAEL, CA (US)

(72) Inventor: Gunjan Porwal, Bangalore (IN)

(73) Assignee: AUTODESK, INC., SAN RAFAEL, CA (US)

(21) Appl. No.: 14/252,538

(22) Filed: Apr. 14, 2014

(51) Int. Cl. H04L 29/06; H04L 12/26; H04L 29/08

(52) U.S. Cl. CPC H04L 63/0861; H04L 67/306; H04L 63/083; H04L 43/04

(57) ABSTRACT

A method, apparatus, system, article of manufacture, and computer program product provide the ability to provide three-dimensional (3D) content. A user is authenticated and authorized to view the 3D content. The 3D content is displayed. A change in the user state is detected. Based on the user state change, two-dimensional (2D) content is displayed instead of the 3D content.

### CROSS-REFERENCE TO RELATED APPLICATIONS

This application is related to the following co-pending and commonly-assigned patent application, which application is incorporated by reference herein:

U.S. patent application Ser. No. 11/729,211 filed on Mar. 28, 2007, now U.S. Pat. No. 7,782,319 issued on Aug. 24, 2010, entitled “THREE-DIMENSIONAL ORIENTATION INDICATOR AND CONTROLLER”, by Anirban Ghosh, et. al, Attorney Docket No. 30566.413-US-01.

U.S. patent application Ser. No. 13/901,895 filed on May 24, 2013, entitled “STEREOSCOPIC USER INTERFACE, VIEW, AND OBJECT MANIPULATION,” by Gunjan Porwal, Attorney's docket number 30566.491-US-U1, which application claims the benefit of U.S. Provisional Patent Application Ser. No. 61/651,150 filed on May 24, 2012, entitled “STEREOSCOPIC USER INTERFACE, VIEW, AND OBJECT MANIPULATION,” by Gunjan Porwal, Attorney's docket number 30566.492-US-P1;

U.S. patent application Ser. No. 13/910,808 filed on Jun. 5, 2013, entitled “CONFIGURABLE VIEWCUBE CONTROLLER,” by Gunjan Porwal, Attorney's docket number 30566.492-US-U1, which application claims the benefit of U.S. Provisional Patent Application Ser. No. 61/658,294, filed on Jun. 11, 2012, by Gunjan Porwal, entitled “CONFIGURABLE VIEWCUBE CONTROLLER,” attorneys' docket number 30566.492-US-P1; and

U.S. patent application Ser. No. 13/796,619 filed on Mar. 12, 2013, entitled “SHADOW RENDERING IN A 3D SCENE BASED ON PHYSICAL LIGHT SOURCES,” by Murali Pappoppula and Gunjan Porwal, Attorney's docket number 30566.496-US-01.

### BACKGROUND OF THE INVENTION

1. Field of the Invention

The present invention relates generally to three-dimensional (3D) graphics applications, and in particular, to a method, apparatus, and article of manufacture for environment based switching between two-dimensional (2D) views and 3D views.

2. Description of the Related Art

Current stereoscopic displays play 3D content continuously once the 3D mode is set to ON. However, it is sometime of interest to a user to watch content in 2D, or it is beneficial for a stereoscopic display system to turn off 3D in some cases.

The following are some use cases when the user might want the display to turn off 3D:
1. User takes off his 3D stereoscopic glasses while sitting in front of stereoscopic screen. It is clear that the user is not interested in watching 3D anymore.
2. User goes for a break, and comes back and does not wear the 3D glasses.
3. Multiple users come before a stereoscopic (or autostereoscopic) display, and the one or more users are not wearing 3D glasses, or the autostereoscopic display cannot support showing 3D for multiple users.

The below use cases highlight when the system might turn off 3D for better performance:
1. There is no one in front of the stereoscopic display. The system has to do extra processing for displaying 3D and so can turn it off.
2. The system is running low on battery (when the battery level goes below a threshold in case of handheld devices or notebooks) and it is critical to turn off 3D to save battery.
3. The system detects that the battery of the 3D glasses (for one or more users) is depleted and needs recharging.
4. The system detects a user watching content not meant for his profile (Such as a child watching violence in 3D—without adult supervision—although its rated R).

In view of the above, there are various exemplary scenarios when it is desirable that 3D stereoscopic content should be displayed in 2D rather than 3D.

### SUMMARY OF THE INVENTION

Embodiments of the invention provide the ability to switch from displaying content in 3D to a 2D version of such content based on a variety of variables (e.g., environmental variables and/or processing/content specific variables). Environmental variables may include a determination that 3D stereoscopic glasses have been removed or are not on a user(s). Processing/content specific variables may include processing/battery capabilities/status, content/user based restrictions (e.g., user based authentication/subscription compliance), etc.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system used in accordance with one or more embodiments of the invention; and

FIG. 3 illustrates the logical flow for providing/enabling the viewing of 3D content in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide a mechanism for switching (and/or activating a trigger for switching) between a 2D view and a 3D view of content.

### Hardware Environment

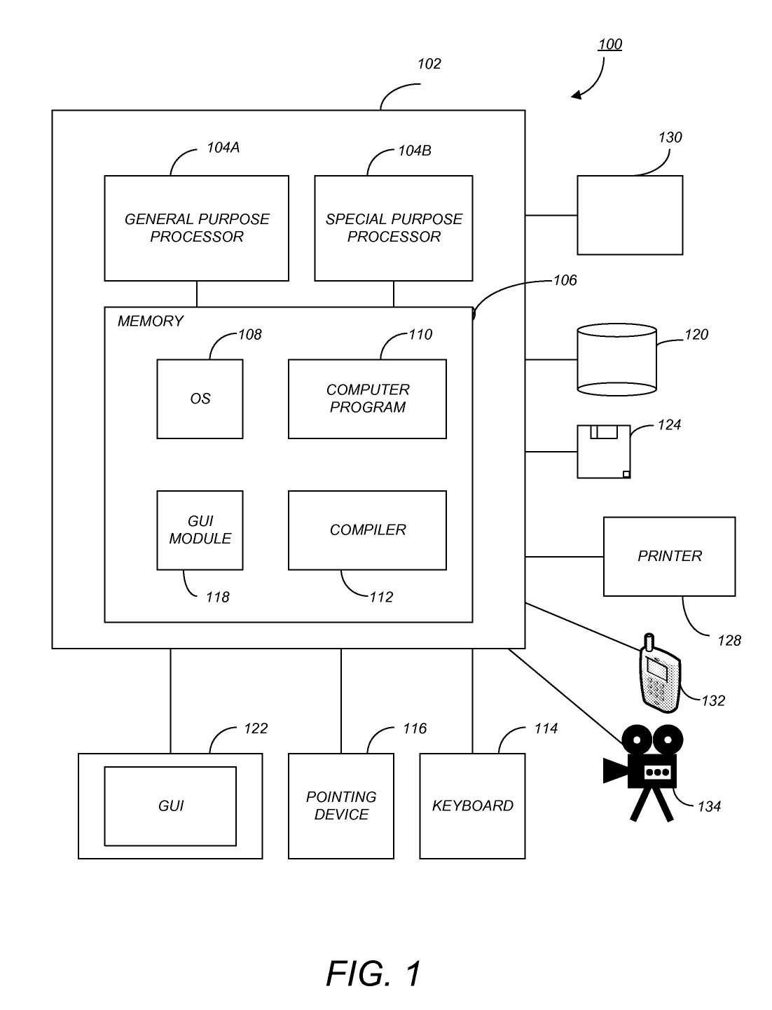

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands.

In various embodiments of the invention, the display 122 is a 3D display device which may comprise a 3D enabled display (e.g., 3D television set or monitor), a head mounted display (e.g., a helmet or glasses with two small LCD or OLED [organic light emitting diode] displays with magnifying lenses, one for each eye), active or passive 3D viewers (e.g., LC shutter glasses, linearly polarized glasses, circularly polarized glasses, etc.), etc. In this regard, any technique that may be utilized to view 3D stereoscopic images is represented by display 122. Further, one or more stereoscopic cameras 134 may be configured to communicate with computer 100 to enable a 3D display on 3D display 122. Stereoscopic cameras 134 may consist of any device that is capable of interpreting depth based data such as a laser scanning device, a Microsoft™ Kinect™ device, etc.

In an exemplary configuration, a 3D enabled display 122 (e.g., a stereoscopic television set) has a camera and microphone based controller (e.g., a Microsft™ Kinect™ or similar device) (illustrated as stereoscopic camera 134 in FIG. 1) communicatively coupled/attached to it.

The 3D image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, cause the computer 102 to perform the steps necessary to implement and/or use the present invention or to load the program of instructions into a memory 106, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

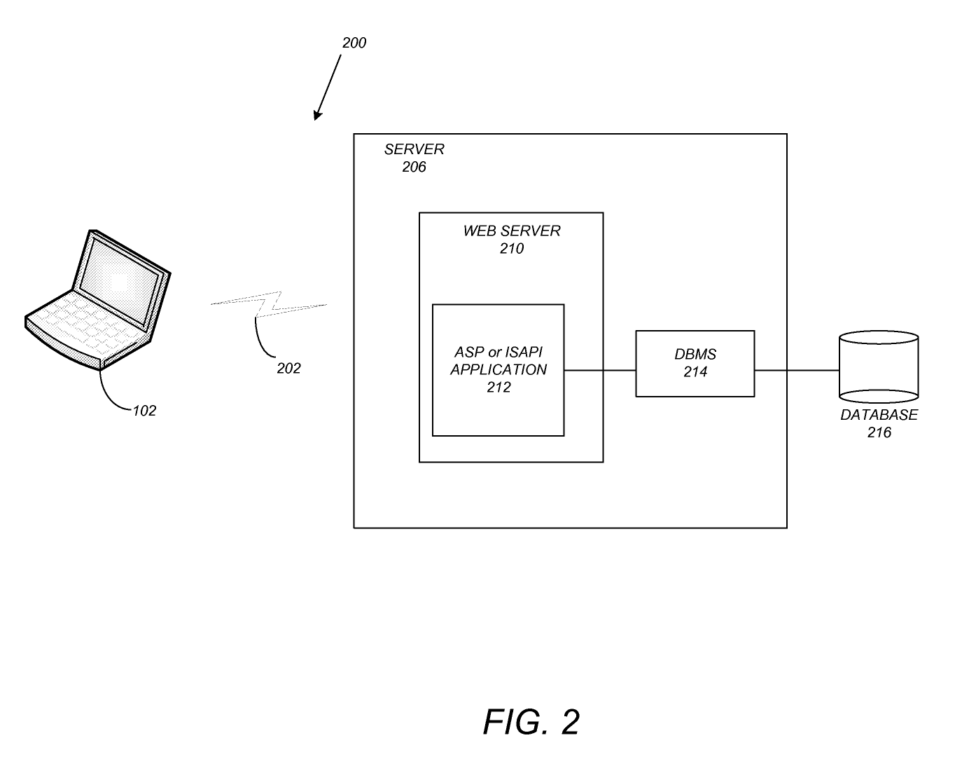

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 in accordance with embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 102 may be downloaded from server computer 206 to client computers 102 and installed as a plug-in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 102 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 102 and 206.

Embodiments of the invention are implemented as a software application on a client 102 or server computer 206. Further, as described above, the client 102 or server computer 206 may comprise a thin client device or a portable device that has a multi-touch-based and/or 3D enabled display capability.

### Exemplary Embodiment for Switching Between 2D and 3D

As used herein, content includes video, images, objects, etc. Similarly, 3D content includes any image/video that contains a object or other graphic that has a 3D property. One or more parts of an image/scene/video may be 3D and/or 2D. Different versions (e.g., one 3D version and another 2D version) of the same base content may be created and used in accordance with embodiments of the invention.

As described above, an exemplary configuration includes a stereoscopic television that has a camera and microphone based controller (e.g., similar to a Microsoft™ Kinect™ sensor) attached to it. Such a configuration detects the user standing in front of the sensor/controller.

Based upon a request to watch content (e.g., 3D content or 2D content), the user (and/or multiple users) may be authenticated. As used herein, authentication is the act of confirming the identity of the user. Authentication may be performed using a variety of techniques. For example, facial recognition methodologies may be used to identify the user. In addition, if required, voice based command activation may be used to provide further confirmation/authentication of the user.

Once a user has been authenticated, a authorization determination is made regarding whether the requesting user is authorized to view the requested content. Such authorization is the process of verifying that the user is permitted to view the requested content (which is distinct from the authentication process which confirms the identity of the user).

For example, the authorization process may determine whether a child standing in front of a stereoscopic display (e.g., with a connected camera and/or microphone to identify the user through face recognition and/or voice command) is restricted from disabling/turning off 3D without adult supervision. Similarly, depending on the authorizations/permissions associated with a particular user, the user may be restricted from viewing 3D content. For example, a user may not have access permissions (such as a valid subscription to access particular content) to view 3D content (e.g., versus 2D content). Such restrictions may be based on information specific to the user (e.g., age, location, etc.) as well as the content (e.g., motion picture association rating, parent-based restrictions, valid subscription, etc.). In this regard, access permissions may be established in variety of contexts including cable/satellite television services, subscription based viewing services (e.g., Netflix™, Amazon Prime™, etc.), subscription based online services (e.g., Xbox™ Live™, or other gaming console subscription services), or any other system where a user account/identity is compared to permissions for such a user.

Upon successfully authenticating and authorizing the user, display of the 3D content may commence. Once the 3D content playback has started, the controller camera may continuously scan the user's state. For example, a controller may actively monitor for a change in whether the user is wearing 3D stereoscopic glasses. The detection (e.g., of a change in the users' glass wearing state) can be performed in a variety of different ways such as:
Image processing using a computer vision algorithm to detect the presence of 3D glasses on the user's face;
Sensors embedded within the 3D glasses to detect body heat to know whether they are being used by the user; or
Vibration sensors in the 3D glasses to detect continuous face movement;
Etc.

If the controller detects that the user has stopped wearing 3D glasses, it can automatically switch the content from 3D to 2D. Alternatively, if multiple users are sitting together, and one (1) user has taken off the 3D glass, the system may query the user to determine if the user wishes to continue playback in 3D. In another alternative, if the user has gone away from his/her position, and comes back and is not wearing 3D glasses, the system can switch back the playback to 2D.

In another case, the system itself can initiate switching from 3D to 2D. This can be in different scenarios such as if the controller camera detects that there is no viewer in front of the display. Based on such a detection, the system can switch the content playback to 2D to save bandwidth, processing power or battery as the case may be. When any user appears in front of the screen, the system may switch the content back to 3D (e.g., based upon authentication and valid authorization [e.g., in case restricted content is playing]).

In another embodiment, the system can switch the display back to 2D if the device is running low on battery and the system detects that the user is outside of the user's home or office (and so does not have possible access to charging the user's handheld device or notebook). The system may also keep scanning for the user in front of the screen, and if the user in front of the screen changes, it can stop showing the playback in 3D if the new user is not authenticated and/or does not have authorization to watch the content in 3D. In one example, the authentication process may include popping up an authentication challenge (in the form of facial recognition or voice password or login-password mechanism) to figure out if the new user is authenticated. Based on the authentication, verification/confirmation of the user's authorization to watch the content in 3D may be performed. If either the authentication or the authorization fails, the system can switch back to 2D.

In the reverse scenario, if the user picks up 3D glasses, the system can automatically switch from 2D to 3D (e.g., if authentication and authorization are properly confirmed [if required]).

### Logical Flow

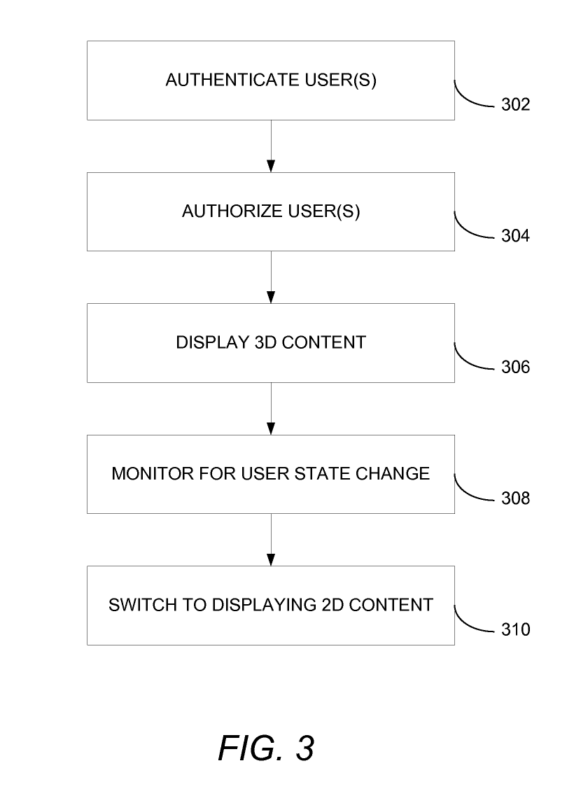

The logical flow for providing/enabling the viewing of 3D content may be divided into various different parts/steps. FIG. 3 illustrates such a logical flow in accordance with one or more embodiments of the invention.

At step 302, one or more users are authenticated. The user authentication may be in the form of facial recognition, profile recognition, voice authentication, biometric recognition, and/or login-password mechanism.

At step 304, the user(s) are authorized (or a determination is made regarding whether they are authorized) to view the 3D content.

At step 306, the 3D content is displayed.

At step 308, the system/controller monitors for (and/or detects) a change in the user state. Such a change in the user state may be the removal of 3D stereoscopic glasses (e.g., by one or more users), the user returning to a viewing area without wearing 3D glasses, a lack of presence of the user in front of a stereoscopic display (e.g., the user leaves the viewing area in front of a 3D display), a low battery indication on a system configured to display the 3D content (e.g., low battery on handheld devices, laptop computers, tablets, etc.), a low battery indication on 3D stereoscopic glasses required to view the 3D content, and/or a change in the authorization of one or more of the users attempting to view the 3D content (e.g., a minor is attempting to watch restricted content in 3D, a subscription has changed/expired, etc.).

At step 310, based on the user state change, two-dimensional (2D) content is displayed instead of the 3D content.

Thus, in view of the above, the first part of the process of FIG. 3 is that of authenticating 302 and authorizing 304 one of more users to view 3D content. The second part of the process deals with display of content on the display (i.e., steps 306-310). Upon authentication and authorization, if authentication or authorization fails, there might be different ways to prevent the user from seeing the restricted content. One mechanism is that the software can restrict the display of content (i.e. it can prevent displaying of the second (2^{nd}) frame required for stereoscopic viewing. Alternatively, the change/switch from displaying 3D content to displaying 2D content may occur at the display level (i.e. the display can block the displaying of additional frames required for stereoscopic viewing). Alternatively, the lenticular lens mechanism required for autostereoscopic viewing (e.g., within 3D glasses or in the display itself) may be disabled. Alternatively, the display contents may be scrambled so as not to allow the user to see restricted content if authentication/authorization is unsuccessful.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for providing three-dimensional (3D) content, comprising:
authenticating a user;
authorizing the user to view the 3D content;
displaying the 3D content;
monitoring for a user state change; and
based on the user state change, displaying two-dimensional (2D) content instead of the 3D content.

2. The computer-implemented method of claim 1, wherein the authenticating the user comprises performing facial recognition.

3. The computer-implemented method of claim 1, wherein the authenticating the user comprises performing profile recognition.

4. The computer-implemented method of claim 1, wherein the authenticating the user comprises performing voice authentication.

5. The computer-implemented method of claim 1, wherein the authenticating the user comprises performing biometric recognition.

6. The computer-implemented method of claim 1, wherein the authenticating the user comprises performing login-password authentication.

7. The computer-implemented method of claim 1, wherein the user state change comprises a removal of 3D stereoscopic glasses.

8. The computer-implemented method of claim 1, wherein the user state change comprises the user returning to a viewing area without wearing 3D stereoscopic glasses.

9. The computer-implemented method of claim 1, wherein the user state change comprises a lack of presence of the user in front of a stereoscopic display.

10. The computer-implemented method of claim 1, wherein the user state change comprises a low battery indication on a system configured to display the 3D content.

11. The computer-implemented method of claim 1, wherein the user state change comprises a low battery indication on 3D stereoscopic glasses required to view the 3D content.

12. The computer-implemented method of claim 1, wherein the user state change comprises a change in the authorization of the user.

13. A system for providing three-dimensional (3D) content comprising:
(a) a stereoscopic display means configured to display the 3D content;
(b) a controller communicatively coupled to the stereoscopic display means, wherein the controller is configured to:
(1) authenticate a user;
(2) authorize the user to view the 3D content;
(3) display the 3D content on the stereoscopic display means;
(4) monitor for a user state change; and
(5) based on the user state change, display two-dimensional (2D) content instead of the 3D content on the stereoscopic display means.

14. The system of claim 13, wherein the controller is configured to authenticate the user using facial recognition.

15. The system of claim 13, wherein the controller is configured to authenticate the user using profile recognition.

16. The system of claim 13, wherein the controller is configured to authenticate the user using voice authentication.

17. The system of claim 13, wherein the controller is configured to authenticate the user using biometric recognition.

18. The system of claim 13, wherein the controller is configured to authenticate the user using login-password authentication.

19. The system of claim 13, wherein the user state change comprises a removal of 3D stereoscopic glasses.

20. The system of claim 13, wherein the user state change comprises the user returning to a viewing area without wearing 3D stereoscopic glasses.

21. The system of claim 13, wherein the user state change comprises a lack of presence of the user in front of the stereoscopic display means.

22. The system of claim 13, wherein the user state change comprises a low battery indication on the system configured to display the 3D content.

23. The system of claim 13, wherein the user state change comprises a low battery indication on 3D stereoscopic glasses required to view the 3D content.

24. The system of claim 13, wherein the user state change comprises a change in the authorization of the user.
